(19) United States
(12) Patent Application Publication
(10) Pub. No.: US 2022/0036477 A1
(43) Pub. Date: Feb. 3, 2022

(54) SYSTEM AND METHOD FOR DETERMINING REVENUE GENERATED BY ANY ZONE IN A WEBPAGE

(71) Applicant: Content Square SAS, Paris (FR)

(72) Inventors: Luis DIAZ, Paris (FR); Lionel SEGUIN, Paris (FR)

(73) Assignee: Content Square SAS, Paris (FR)

(21) Appl. No.: 16/940,800

(22) Filed: Jul. 28, 2020

(51) Int. Cl. G06Q 40/00; G06Q 30/02; G06Q 40/02; G06F 16/955; G06F 16/958; H04L 29/08; G06F 3/0482

(52) U.S. Cl. CPC G06Q 40/12; G06Q 30/0201; G06Q 40/02; H04L 67/36; G06F 16/958; H04L 67/14; G06F 3/0482; G06F 16/955

(57) ABSTRACT

A system and method for determining revenue generated by zones in a webpage are provided. The method includes receiving session interaction data gathered from a plurality of user devices of a plurality of visitors visiting the webpage during a plurality of sessions; determining, for each session, and for session interaction data received from each user device of the plurality of user devices, if the respective session interaction data includes a purchase event, wherein the purchase event is indicative of a completion of a transaction; generating zone revenue data per session by analyzing session interaction data with purchase events; aggregating the generated zone revenue data across multiple sessions recorded for the plurality of visitors visiting the webpage, wherein the aggregated revenue data lists all zones in the webpage which contributed to a completion of the transaction; and reporting the aggregated revenue data.

### TECHNICAL FIELD

The present disclosure relates generally to webpage zone analysis and, particularly, to systems and methods for determining the revenue generated by any zone in a webpage.

### BACKGROUND

As businesses continue to expand online operations in retail, advertising, and other, like, fields, online sales and services may account for increasingly-large portions of a business's revenue. While website owners, operators, and administrators may enjoy expanded reach into previously-inaccessible markets due to the implementation of web technologies, the same technologies, if mismanaged or misapplied, may hinder a business's growth or success. Specifically, website layouts and features which distract site visitors from completing transactions on a website may reduce the site's efficacy as a source of revenue. As a result, webpage operators, owners, and administrators may seek an enhanced understanding of the impact of various aspects of a website on the site's revenue generation, particularly at a granular level.

Certain methods of web revenue analysis may allow for broad understandings of the impact of site features on revenues. Site operators, owners, and administrators may manually correlate site revenues with implemented changes, thereby generating an understanding of a specific change's impact on site revenue.

However, such manual correlative methods fail to provide automatic detection of revenues on a per-zone basis, preventing interested parties from understanding the contribution of each site feature to revenue generation. Further, such solutions lack the efficiencies which may be required to generate valuable insights into site performance, particularly for large, global businesses, due to the time and effort outlay required to collect, analyze, and present relevant data.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for determining revenue generated by zones in a webpage. The method comprises receiving session interaction data gathered from a plurality of user devices of a plurality of visitors visiting the webpage during a plurality of sessions; determining, for each session, and for session interaction data received from each user device of the plurality of user devices, if the respective session interaction data includes a purchase event, wherein the purchase event is indicative of a completion of a transaction; generating zone revenue data per session by analyzing session interaction data with purchase events; aggregating the generated zone revenue data across multiple sessions recorded for the plurality of visitors visiting the webpage, wherein the aggregated revenue data lists all zones in the webpage which contributed to a completion of the transaction; and reporting the aggregated revenue data.

In addition, certain embodiments disclosed herein include a system for determining revenue generated by zones in a webpage. The system comprises a processing circuitry; and a memory, the memory containing instructions that, when executed by the processing circuitry, configure the system to: receive session interaction data gathered from a plurality of user devices of a plurality of visitors visiting the webpage during a plurality of sessions; determine, for each session, and for session interaction data received from each user device of the plurality of user devices, if the respective session interaction data includes a purchase event, wherein the purchase event is indicative of a completion of a transaction; generate zone revenue data per session by analyzing session interaction data with purchase events; aggregate the generated zone revenue data across multiple sessions recorded for the plurality of visitors visiting the webpage, wherein the aggregated revenue data lists all zones in the webpage which contributed to a completion of the transaction; and report the aggregated revenue data.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various embodiments for determining revenue generated by any zone in a webpage.

FIG. 2 is a flowchart depicting a method for evaluating and presenting revenue attributions for various zones of a webpage or website, according to an embodiment.

FIG. 3 is a flowchart depicting a method for collecting and storing webpage versions and zone revenue data, according to an embodiment.

FIG. 4A is a screenshot of a user interface for presenting zone revenue analyses, according to an embodiment.

FIG. 4B is a screenshot of a user interface depicting a date range selector for zone revenue analyses, according to an embodiment.

FIG. 5 is an example diagram depicting an unlabeled document object model (DOM) tree, according to an embodiment.

FIG. 6 is an example schematic diagram of an analytic server, according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

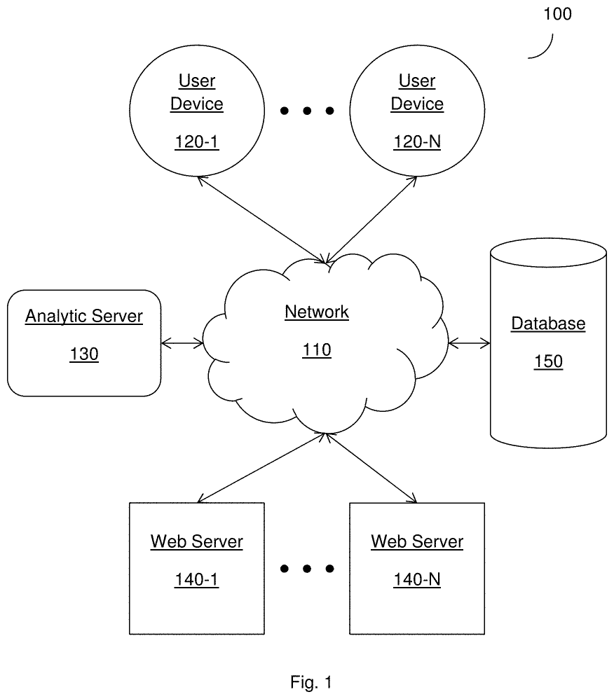

FIG. 1 is an example network diagram depicting a network system 100 disclosing the embodiments for determining revenue generated by any zone in a webpage. The system 100 includes one or more user devices, 120-1 through 120-N (hereinafter, “user device” 120 or “user devices” 120), an analytic server 130, one or more web servers, 140-1 through 140-N (hereinafter “web server” 140 or “web servers” 140), and a database 150. Further, in the system 100, the various components listed are interconnected via a network 110.

The network 110 provides interconnectivity between the various components of the system. The network 110 may be, but is not limited to, a wireless, cellular or wired network, a local area network (LAN), a wide area network (WAN), a metro area network (MAN), the Internet, the worldwide web (WWW), similar networks, and any combination thereof. The network may be a full-physical network, including exclusively physical hardware, a fully-virtual network, including only simulated or otherwise-virtualized components, or a hybrid physical-virtual network, including both physical and virtualized components. Further, the network 110 may be configured to encrypt data, both at rest and in motion, and to transmit encrypted, unencrypted, or partially-encrypted data. The network 110 may be configured to connect to the various components of the system 100 via wireless means such as, as examples and without limitation, Bluetooth™, long-term evolution (LTE), Wi-Fi, other, like, wireless means, and any combination thereof, via wired means such as, as examples and without limitation, ethernet, universal serial bus (USB), other, like, wired means, and any combination thereof. Further, the network 110 may be configured to connect with the various components of the system 100 via any combination of wired and wireless means.

The user devices 120 may be devices allowing a user to interact with the system 100 for purposes including, as examples and without limitation, providing webpage targets to the system 100 for analysis, receiving returns or outputs from the system 100, configuring system 100 parameters, other, like, purposes, and any combination thereof. Further, a user device 120 may be configured to receive returns or outputs from the web servers 140 to view webpages or other content developed by any of the web servers 140. A user device 120 typically includes a web browser (now shown) or any application (virtual, web, mobile, and the like) which allows a user to view, download, interact with, and engage with content provided by the web servers 140, the analytic server 130, or both. Examples of user devices 120 include smartphones, personal computers, business systems, dedicated kiosks, tablet computers, and other, like, devices.

Users of the user devices 120 may access at least one website hosted by the servers 140. The website may be, for example, an online retail platform, an e-commerce platform, and the like. In some embodiments, the user devices 120 can access an application installed on and executed by the servers 140. Such an application may include a mobile application (app), a cloud application, a web application, and the like. The various embodiments are discussed herein with a reference to one or more websites, but are equally applicable to one or more applications.

In an embodiment, a user device 120 may be operated by an administrator of one or more websites hosted by the web server or servers 140. Through the user device 120, reports generated by the analytic server 130 may be viewed. The user device 120 may be further configured to allow for configuration of one or more components of the system 100, issuing or executing instructions, or manipulating data.

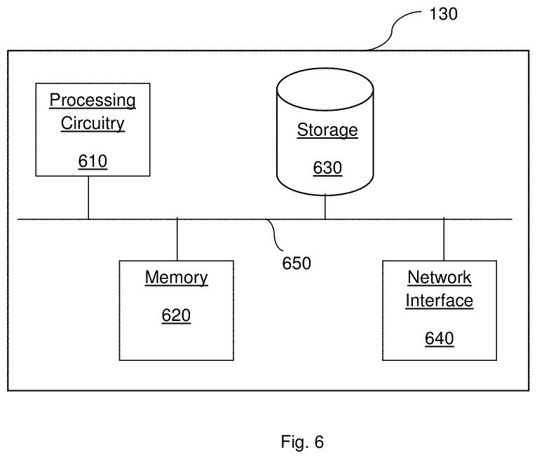

The analytic server 130, described in detail with respect to FIG. 6, below, is a system configured to execute instructions, organize information, and otherwise process data. The analytic server 130 may be configured to execute the methods described hereinbelow, other, like, methods, and any combination thereof. As described with respect to FIG. 6, below, the analytic server 130 may include various processing, memory, networking, and other components allowing the analytic server 130 to execute instructions and provide data processing. The analytic server 130 may be implemented as physical hardware, as software virtualizing physical hardware, or as a combination of physical and virtualized components. The analytic server 130 may be connected to the network 110 via those means described with respect to the network 110, above. The various processes performed by the analytic server 130 are described in greater detail hereinbelow. The analytic server 130 may be deployed in a cloud computing platform, a data center, or as an on-premises deployment.

According to the disclosed embodiments, the analytic server 130 is configured to execute instructions for at least determining revenue generated by zones of a webpage, thereby determining which version of webpage performs better in terms of revenue generation. Zones refer to the various content elements, fields, and the like which, in combination, form the user-facing portions of a webpage or website. As an example, an online shopping website may include a search bar, a “go to cart” button, and a “home page” button, where the search bar and the various buttons are each webpage zones. Additional examples of zones, and the application and analysis thereof, are described hereinbelow. Performance metrics refer to various quantifiable factors related to goal achievement. As an example, where a given goal targets a fifteen percent newsletter sign-up rate, a corresponding performance metric may be the percentage of site visitors clicking on a “subscribe to newsletter” button. Additional examples of performance metrics are described hereinbelow.

The web servers 140 may be one or more web sources of data other than the inputs received from the user devices 120. The web servers 140 may include data relating to websites, data relating to webpages, other, like, data, and any combination thereof. Data from the web servers 140 may be stored in the database 150 and may be processed by the analytic server 130. Web servers 140 may be local web sources, remote web sources, or any combination thereof. Examples of web servers 140 include, without limitation, repositories of webpage information, “live” webpages, other, like, sources, and any combination thereof. Web servers 140 may be connected with the network 110 via the means described hereinabove.

The database 150 is a data store configured to archive data permanently or semi-permanently. The database 150 may be configured to store information received from one or more web servers 140, user devices 120, and other, like, components, as well as to store data relevant to the operation of the analytic server 130 and any outputs therefrom. The database 150 may be a local system, a remote system, or a hybrid remote-local system. Further, the database 150 may be configured as a full-physical system, including exclusively physical components, as a virtualized system, including only virtualized components, or as a hybrid physical-virtual system. Examples of devices which may be configured as a database 150 in the system 100 include, without limitation, local database hardware, cloud storage systems, remote storage servers, other, like, devices, and any combination thereof.

According to an embodiment, the database 150 may be configured to store or otherwise archive data relating to detection, identification, and analysis of webpage sessions including, without limitation, webpages, user interactions, user sessions, other, like, data, and any combination thereof. Further, the database 150 may be configured to transfer, to and from the analytic server 130, data necessary for the execution of the methods described hereinbelow, and may store or otherwise archive analytic server 130 inputs, analytic server 130 outputs, or both.

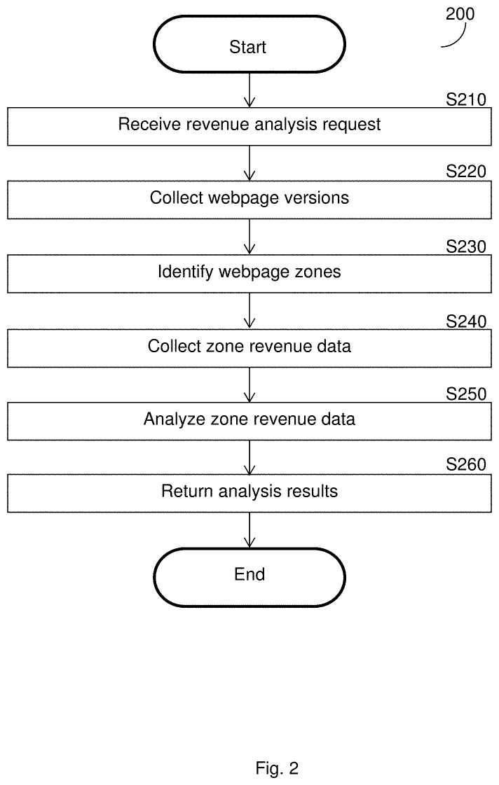

FIG. 2 is an example flowchart 200 depicting a method for evaluating and presenting revenue attributions for various zones of a webpage or website, according to an embodiment.

At S210, a revenue analysis request is received. A revenue analysis request is a message, command, or other request which may configure an analytic system, such as the system described with respect to FIG. 1, above, to determine the aggregate revenue contributions of various zones in a webpage. A revenue analysis request may include data specifying a webpage for analysis, a date for analysis, a revenue analysis date range, and the like, as well as any combination thereof. A revenue analysis request may be generated by, and received from, one or more user devices, such as the user devices, 120, of FIG. 1, above. A revenue analysis request may be generated by user interaction with a revenue analysis request tool or form, as may be included in, or accessed by, a browser (not shown), an application (not shown), or another, like, program, included in a user device.

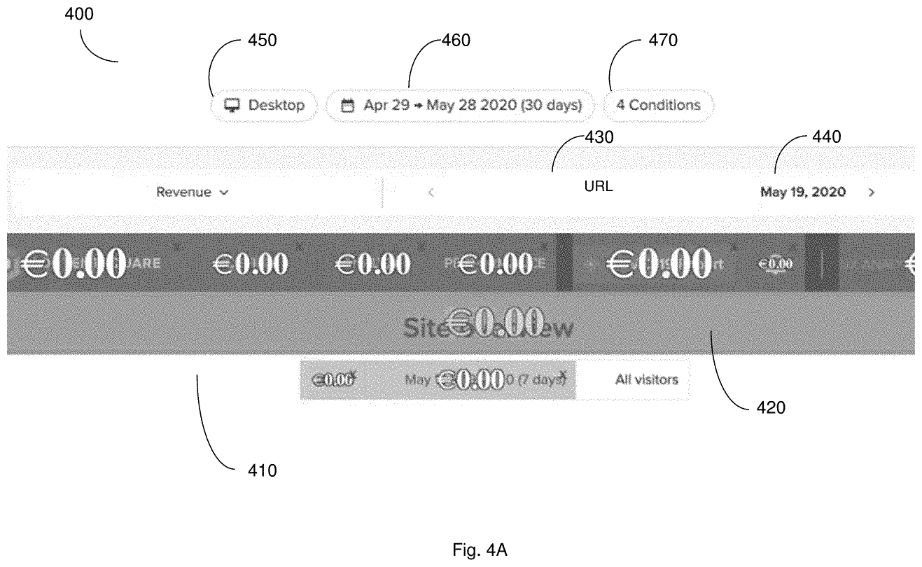

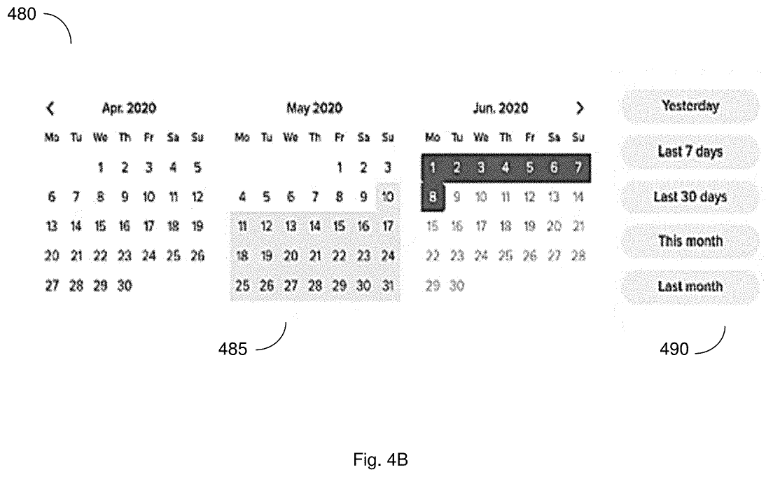

The date specified in the comparison request may be a date for which an archived snapshot of the specified webpage on the specified date may be accessed or retrieved. Where the comparison request does not include a date, the date may be set or updated to be equal to the most recent date for which a webpage snapshot or version is recorded, including the current date at the date of revenue analysis request receipt. The various features included in a revenue analysis request are described in greater detail with respect to FIG. 4A, below.

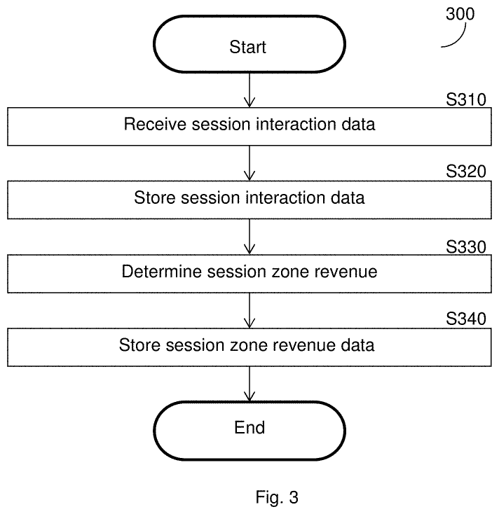

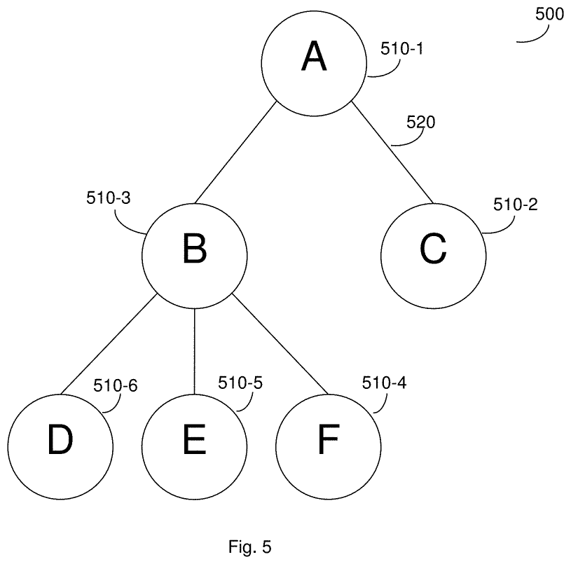

At S220, webpage versions are collected. Webpage versions are one or more versions of the same webpage, collected for revenue analysis of the various versions. Webpage versions may include current or “live” webpages, archived webpages, and any combination thereof. Archived webpages may be saved “complete” webpages, webpage resources, webpage background code, such as in hypertext markup language (HTML) and cascading style sheets (CSS), webpage document object models (DOMs), and the like, as well as any combination thereof. A detailed description of webpage DOMs is provided with respect to FIG. 5, below. Webpage versions may be collected from sources including, without limitation, the web servers 140 and database 150 of FIG. 1, above. Webpage versions may be collected where the collected webpages include a date stamp, tag, label, or other date-indicating data feature, matching a date included in the comparison request received at S210. The collection of webpage versions is described in greater detail with respect to FIG. 3, below.

At S230, webpage zones are identified. Webpage zones are those zones of a webpage version, such as the webpage versions collected at S220, which are relevant to the revenue analysis request received at S210. Webpage zones may be identified by a specification of certain zones or types of zones, such as in the received revenue analysis request, by specification of zones or types of zones relevant to revenue analysis, such as may be specified in the received revenue analysis request, and by other, like, means. Webpage zones may be webpage zones, elements, or other, like user-facing features, with which a user may interact in a manner capable of generating zone revenue data, such as the zone revenue described with respect to S230, below. As an example, a webpage zone may be a “cart” button, with which users may have interacted by clicking, with each click contributing to the zone's aggregate revenue value.

Webpage zones may be identified in one or more webpage versions, such as those collected at S220, including both current or “live” webpages, as well as archived webpages. Webpage zones may be identified by application of one or more zone-identification algorithms, scripts, or methods. Identified webpage zones may be recorded by means including, without limitation, attaching a data label or tag to relevant sections of a complete webpage, a webpage's HTML code, or a webpage's DOM, by generating corresponding files specifying the identified content zones, by other, like, methods, and any combination thereof.

At S240, zone revenue data is collected. Zone revenue data is data describing the revenue contribution of zones, as identified at S230, to aggregate webpage or website revenue. Zone revenue data may include, as an example, the total revenue generated in a given session, the zone interactions recorded for a given session, and the like. Zone revenue data may be collected from one or more zone revenue data repositories. Where zone revenue data is retrieved for a specified date range, the retrieved zone revenue data may include only zone revenue data collected during the specified date range. The selection of zone revenue data date ranges is described in greater detail with respect to FIG. 4B, below.

In an embodiment, discussed in greater detail below, zone revenue data is generated per zone, for each webpage. The zone revenue data may be generated by traversing, or tracing back, a purchase event. That is, when a user adds an item to a cart and completes the transaction, all zones that the user interacts with are considered as having contributed to the completion of the transaction and, hence, to revenue. Thus, the zone revenue data includes a list of zones which contributed to the completion of the transaction, and the corresponding purchase amount, expressed in terms of currency. The zone revenue data, per session, may be saved, for example, in the database 150, FIG. 1, above. The zones and the purchase events are included in session interaction data gathered by a tracking tag executed on a browser and sent to one or more analytic servers, such as the analytic server, 130, of FIG. 1, above.

At S250, collected zone revenue data is analyzed. Zone revenue data may be analyzed to determine zone contributions to aggregate revenue. Comparison zone metric analysis may include, without limitation, determining the aggregate revenues generated by each session including an interaction with a given zone or element, the contribution of each zone for a specific day or a range of dates, and the like, as well as any combination thereof. As an example, where zone revenue data includes five sessions, each including a generated revenue value of $500 USD, and each including an interaction with a “proceed to checkout” button, zone revenue data analysis may include the attribution of $2,500 USD in revenue to the “proceed to checkout button.”

In an embodiment, execution of S250 may occur concurrently with S260. Where execution of S250 occurs concurrently with S260, and where S260 includes returning analysis data in one or more visual formats, including that described with respect to FIG. 4A, below, zone revenue data may be analyzed in real-time or near-real-time as a user interacts with the one or more visual outputs. As an example, where S260 and S250 occur simultaneously, and where S260 includes presenting a webpage version including revenue value overlays, revenue values displayed in the included revenue value overlays may be calculated, as described herein, for each zone or element of the webpage as the user clicks on or hovers over the respective zones or elements.

At S260, analysis results are returned. Analysis results include outputs and other results of the analyses executed at S250. Analysis results may be returned in formats including, without limitation, marked webpages, HTML codebases, DOM trees and the like, as webpage-independent tables, charts, and the like, as machine-interpretable datasets, such as comma-separated value (CSV) files, in other, like, formats, and any combination thereof. Where analysis results are returned as marked webpages, the returned marked webpages may include zone-level revenue analyses, indicating the revenue values of each identified zone included in the webpage. Examples of visual outputs returned at S260 are described with respect to FIG. 4A, below.

FIG. 3 is an example flowchart 300 depicting a method for generating and storing webpage versions and zone revenue data, according to an embodiment.

At S310, session interaction data is received. The session interaction data is gathered through a tracking tag included in a webpage, as may be accessible through a browser installed on a user device, such as the user device, 120, of FIG. 1. In an embodiment, the tracking tag is a script downloaded to the user device's browser as part of the webpage. In some example configurations, the tracking tag may be realized as an agent, or an application, installed in the user device.

The session interaction data is data describing a user's interactions with a website during a session. A session is a period occurring between a user's initial connection with a website and the same user's disconnection with a website, wherein a user may interact with website zones, elements, or features, such as by, as examples and without limitation, clicking on a zone or element, scrolling down a webpage, hovering over an element, and the like, as well as any combination thereof. Session interaction data may be collected by one or more means including, without limitation, collection by a browser extension included in a browser installed on a user device, such as the user device, 120, of FIG. 1, above, collection by a feature of an application installed on a user device, such as the user device, 120, of FIG. 1, above, collection by one or more tracking tags or features included in a webpage's underlying codebase, such as the page's HTML, by other, like, means, as well as any combination thereof. Where session interaction data is collected by means of a tracking tag included in a webpage's codebase, such a tracking tag may be configured to be, from the perspective of a site visitor, invisible and non-interactive, and may be configured to collect one or more types of user interactions including, without limitation, clicks, hovers, keystrokes, scrolls, and the like.

Session interaction data may be collected by recording one or more user interactions, such as clicks, hovers, keystrokes, and the like, as well as the respective targets of the various interactions. Interaction targets may be webpage zones or elements with which the user interacts by those interactions described hereinabove. Interaction targets may be identified by application of one or more webpage zone identification techniques. Webpage zone identification techniques may include, without limitation, analyses of webpage HTML code, analyses of webpage document object models (DOMs), other, like, analyses, and any combination thereof, wherein such analyses may be configured to identify content elements and zones within a webpage. An example DOM is described in greater detail with respect to FIG. 5, below.

At S320, the received session interaction data is stored. Such data may be stored in one or more formats including, without limitation, lists or ordered sequences of interactions, interaction-by-interaction recordings, including as video, per-zone or per-element interaction counts, in other, like, formats, and any combination thereof. Session interaction data may be saved to one or more repositories or data storage entities including, without limitation, the database, 150, of FIG. 1, above.

At S330, session interaction data is analyzed to determine zone revenue data per session. The zone revenue data is data describing the total revenue generated during a session for each zone interacted with during the session. Revenue may include data relating to, without limitation, sales, subscriptions, donations, refunds, exchanges, and the like, as well as any combination thereof.

In an embodiment, S330 includes determining if the session interaction data includes a purchase event, such as an event indicating a completion of a transaction. The transaction may include a monetary transaction may include a sale, a subscription, a donation, a refund, an exchange, and the like. When such an event is not identified, then no zone revenue data can be determined. When a purchase event is identified, then zone revenue data can be determined. To this end, all zones that a user interacted with during the session are recorded.

Interactions with a zone include, without limitation clicking on a zone, scrolling through a zone, hovering over a zone, zooming into or out of a zone, and the like. For example, a user may hover over an image of a first product, click on an image of the second product, review a text selection related to the second product, add the second product to the cart, and then purchase the second product. In this example, the zoning revenue data includes the image of the first product, the image of the second product, the text selection, and the purchase amount.

At S340, the zone revenue data determined per session is stored. The zone revenue data may be stored in one or more formats including, without limitation, lists, tables, charts, machine-interpretable formats such as comma-separated value (CSV) files, other, like, formats, and any combination thereof. The zoning revenue data may be stored with an association to a respective URL of a webpage from which the data was collected.

FIG. 4A is an example a screenshot 400 of a user interface (UI) for presenting zone revenue analyses, according to an embodiment. The UI includes various features which may be configured to provide for a visual representation of zone revenue analysis results, such as may be returned at S260 of FIG. 1, above. The UI includes a page viewing pane, 410, where the viewing pane includes a version of a specified website, as may be selected using the uniform resource locator (URL) selector 430, at the date selected using the corresponding page date selector, 440, where the website version displayed is collected as part of an evaluation process, such as at S220 of FIG. 2, above. The UI depicted in the screenshot 400 further includes multiple zone revenue evaluation overlays 420. Zone revenue evaluation overlays 420 provide zone revenue data, as may be analyzed, such as at S250 of FIG. 2, above, for the respective version of the displayed webpage on a per-zone basis. Zone revenue data included in the zone revenue evaluation overlays 420 is aggregate zone revenue data collected, as described hereinabove, and filtered by application of the view mode selectors 450, the date range selectors 460, and the conditions selector 470.

In an embodiment, the zone revenue evaluation overlays 420 display zone revenue values corresponding to the sum of revenues generated by sessions including interactions with the various zones of the specified webpage, where the zone revenue for each session may be determined as described with respect to S330 of FIG. 3, above. As an example, where a session generating $500 USD included a click on a first button, and where two sessions, each generating $250 USD, included clicks on a second button, the zone revenue evaluation overlay 420 for the first zone would include an amount indicating $500 USD in transactions, with the same amount included in the zone revenue evaluation overlay 420 corresponding to the second zone. In an embodiment, amounts displayed in zone revenue evaluation overlays 420 may be calculated in real-time or near-real-time upon selection of a given zone by an evaluator, administrator, or other user. Further, in the same embodiment, amounts displayed in zone revenue evaluation overlays 420 may be calculated based on revenue data collected previously, including data collected as described with respect to FIG. 3, above.

The page date selector 440 may be configured to provide for selection of various versions of a webpage from a repository of available versions. The page date selector 440 may be configured to provide for selection only of dates corresponding to webpage versions included in the repository. The user interface depicted in the screenshot 400 further includes a URL selector 430. The URL selector 430 may be configured to provide for presentation of one or more webpages matching one or more selected URLs. The URL selector 430 may be configured to provide for selection of URLs from a pre-defined list, including, without limitation, a list populated by URLs matching webpage versions archived in one or more repositories, including, without limitation, webpage versions archived according to the method described with respect to S220 of FIG. 2, above.

The view mode selector 450 may be configured to provide for selection of a view mode from a list of view modes. A view mode may be a website configuration designed and implemented for a specific device or family of devices, such as mobile devices, desktop computers, and the like. The date range selector 460 may be configured to provide for selection of one or more date ranges, for which applicable zone revenue values are calculated from the collected zone revenue values. The operation of the date range selector 460 is described in detail with respect to FIG. 4B, below. The conditions selector 470 may be configured to provide for the selection of miscellaneous data filters for purposes such as, as examples and without limitation, evaluating only data generated from users in a particular country, evaluating data for all users but users having internet protocol (IP) addresses within a given range of IP addresses, for other, like, purposes, and any combination thereof.

FIG. 4B is an example screenshot 480 of a user interface depicting a date range selector 460 for zone revenue analyses for a webpage, according to an embodiment. The date range selector 460 may be configured to provide for calculations of zone revenue, as described hereinabove, using data collected during a specified date range. The date range selector 460 includes multiple date-selection panes 485, which may be configured as seven-day calendars, depicting various days, months, weeks, and the like.

In one embodiment, the date range selector 460 may be further configured to provide for selection of a date range beginning on a first clicked date and ending on a second clicked date. In addition, the selector includes a quick-selection feature 490, which may be configured to provide for selection of various pre-defined date ranges including, as examples and without limitation, the previous day, the previous seven days, the previous thirty days, the current calendar month, the previous calendar month and other, like, ranges. In an embodiment, the date range selector 460 may be configured to provide for selection of multiple date ranges in a single selection, providing for isolated analysis of zone revenue data during only those periods selected.

The embodiments described herein are related to determining revenue contributed by a zone in a webpage, however, the same embodiments may be related to other metrics, such as conversion rate, click through rate, and the like.

FIG. 5 is an example diagram depicting an unlabeled document object model (DOM) tree 500, according to an embodiment. The unlabeled DOM tree 500 provides a visual representation of the hierarchical structure of a webpage's HTML code, with content zones or elements represented as nodes, 510-1 through 510-6 (hereinafter, “nodes” 510). In the example unlabeled DOM tree 500, related nodes 510 are joined by “links” 520, representing the relationships between two nodes 510. In the example unlabeled DOM tree 500, links 520 are established between nodes 510-1 and 510-2 and between nodes 510-3 and 510-1.

In the example unlabeled DOM tree 500, nodes 510-3 and 510-2 are disposed on a second tier below the first tier occupied by node 510-1, reflecting a structure wherein the content element or zone represented by node 510-1 includes the content elements or zones represented by nodes 510-2 and 510-3. Although only the link 520 between nodes 510-1 and 510-2 is labeled, this label is provided for simplicity, and other, like, links 520 may be likewise labeled without loss of generality or departure from the scope of the disclosure.

FIG. 6 is an example schematic diagram of an analytic server 130, according to an embodiment. The analytic server 130 includes a processing circuitry 610 coupled to a memory 620, a storage 630, and a network interface 640. In an embodiment, the components of the server 130 may be communicatively connected via a bus 650.

The processing circuitry 610 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read only memory, flash memory, etc.), or a combination thereof.

In one configuration, software for implementing one or more embodiments disclosed herein may be stored in the storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 640 allows the analytic server 130 to communicate with the various components, devices, and systems described herein for determining revenue generated by any zone in a webpage, and other, like, purposes.

It should be understood that the embodiments described herein are not limited to the specific architecture illustrated in FIG. 6, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform, such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for determining revenue generated by zones in a webpage, comprising:
receiving session interaction data gathered from a plurality of user devices of a plurality of visitors visiting the webpage during a plurality of sessions;
determining, for each session, and for session interaction data received from each user device of the plurality of user devices, if the respective session interaction data includes a purchase event, wherein the purchase event is indicative of a completion of a transaction;
generating zone revenue data per session by analyzing session interaction data with purchase events;
aggregating the generated zone revenue data across multiple sessions recorded for the plurality of visitors visiting the webpage, wherein the aggregated revenue data lists all zones in the webpage which contributed to a completion of the transaction; and
reporting the aggregated revenue data.

2. The method of claim 1, further comprising:
identifying zones in the collected webpage versions; and
analyzing session interaction data with purchase events to determine which of the identified zones was accessed by a visitor during a session.

3. The method of claim 1, further comprising:
receiving a request to determine revenue data generated by zones in the webpage during a selected date range;
collecting past webpage versions of the website, wherein the past webpage versions are collected for the selected date range;
generating zone revenues for each past webpage version; and
aggregating the generated zone revenue data across multiple past webpage versions.

4. The method of claim 1, wherein zones in the webpage which contributed to a completion of the transaction includes any zone with which a visitor interacted prior to completing a transaction.

5. The method of claim 1, wherein an interaction with a zone includes any one of: clicking on a zone, scrolling through a zone, hovering over a zone, zooming into a zone, zooming out of a zone.

6. The method of claim 1, wherein a transaction includes at least a monetary transaction, wherein the monetary transaction includes a sale, a subscription, a donation, a refund, and an exchange.

7. The method of claim 1, wherein the aggregated revenue data further includes: revenue generated by each zone of the listed zones.

8. The method of claim 7, wherein reporting the aggregated revenue data further comprises:
overlaying the revenue generated by each zone over the webpage with reference to the respective zone.

9. The method of claim 1, wherein the session interaction data is data describing a visitor's interactions with the webpage during a session, wherein a session is a period occurring between a visitor's initial connection with a website and disconnection with the website.

10. The method of claim 1, wherein a zone is a visible element included in the webpage.

11. A non-transitory computer readable medium having stored thereon instructions for causing a processing circuitry to execute a process, the process comprising:
receiving session interaction data gathered from a plurality of user devices of a plurality of visitors visiting the webpage during a plurality of sessions;
determining, for each session, and for session interaction data received from each user device of the plurality of user devices, if the respective session interaction data includes a purchase event, wherein the purchase event is indicative of a completion of a transaction;
generating zone revenue data per session by analyzing session interaction data with purchase events;
aggregating the generated zone revenue data across multiple sessions recorded for the plurality of visitors visiting the webpage, wherein the aggregated revenue data lists all zones in the webpage which contributed to a completion of the transaction; and
reporting the aggregated revenue data.

12. A system for determining revenue generated by zones in a webpage, comprising:
a processing circuitry; and
a memory, the memory containing instructions that, when executed by the processing circuitry, configure the system to:
receive session interaction data gathered from a plurality of user devices of a plurality of visitors visiting the webpage during a plurality of sessions;
determine, for each session, and for session interaction data received from each user device of the plurality of user devices, if the respective session interaction data includes a purchase event, wherein the purchase event is indicative of a completion of a transaction;
generate zone revenue data per session by analyzing session interaction data with purchase events;
aggregate the generated zone revenue data across multiple sessions recorded for the plurality of visitors visiting the webpage, wherein the aggregated revenue data lists all zones in the webpage which contributed to a completion of the transaction; and
report the aggregated revenue data.

13. The system of claim 12, wherein the system is further configured to:
identify zones in the collected webpage versions; and
analyze session interaction data with purchase events to determine which of the identified zones was accessed by a visitor during a session.

14. The system of claim 12, wherein the system is further configured to:
receive a request to determine revenue data generated by zones in the webpage during a selected date range;
collect past webpage versions of the website, wherein the past webpage versions are collected for the selected date range;
generate zone revenues for each past webpage version; and
aggregate the generated zone revenue data across multiple past webpage versions.

15. The system of claim 12, wherein zones in the webpage which contributed to a completion of the transaction includes any zone with which a visitor interacted prior to completing a transaction.

16. The system of claim 12, wherein an interaction with a zone includes any one of: clicking on a zone, scrolling through a zone, hovering over a zone, zooming into a zone, zooming out of a zone.

17. The system of claim 12, wherein a transaction includes at least a monetary transaction, wherein the monetary transaction includes a sale, a subscription, a donation, a refund, and an exchange.

18. The system of claim 12, wherein the aggregated revenue data further includes: revenue generated by each zone of the listed zones.

19. The system of claim 18, wherein the system is further configured to:
overlay the revenue generated by each zone over the webpage with reference to the respective zone.

20. The system of claim 12, wherein the session interaction data is data describing a visitor's interactions with the webpage during a session, wherein a session is a period occurring between a visitor's initial connection with a website and disconnection with the website.

21. The system of claim 12, wherein a zone is a visible element included in the webpage.
